(19) United States
(12) Patent Application Publication
(10) Pub. No.: US 2008/0052308 A1
(43) Pub. Date: Feb. 28, 2008

(54) METHOD AND SYSTEM FOR REALIZING AUTOMATIC ADAPTATION OF DATA OBJECT MODEL

(75) Inventor: Zhiguo Zhang, Shenzhen (CN)

Correspondence Address: AKIN GUMP STRAUSS HAUER & FELD, LLP, P O BOX 688, DALLAS, TX, 75313-0688, US

(73) Assignee: HUAWEI TECHNOLOGIES CO., LTD., Shenzhen (CN)

(21) Appl. No.: 11/843,072

(22) Filed: Aug. 22, 2007

(30) Foreign Application Priority Data
Aug. 22, 2006 (CN) 200610062258.X

(51) Int. Cl. G06F 17/30

(52) U.S. Cl. 707/102; 707/E17.005

(57) ABSTRACT

A method for realizing automatic adaptation of a data object model includes: generating, by a business rule management system (BRMS), a first data object model (DOM) according to a second DOM, the first DOM being a DOM for use with a rule, the second DOM being a DOM provided by an application system; analyzing, by the BRMS, the first DOM, and generating an XML model; obtaining, by the application system, the XML model from the BRMS when determining that the rule of the BRMS changes, and updating a local XML model accordingly; generating, by the application system, an XML file complying with the rule by using the local XML model, and transferring the XML file and the rule identifier to the BRMS; and generating, by the BRMS, a DOM instance by using the XML file, and transferring the DOM instance to a rule engine to trigger the rule.

The present application claims the priority of Chinese Patent Application No. 200610062258.X, filed on Aug. 22, 2006, entitled “METHOD AND SYSTEM FOR REALIZING AUTOMATIC ADAPTATION OF DATA OBJECT MODEL”, which is incorporated herein by reference in its entirety.

### FIELD OF THE INVENTION

The present invention relates to a business rule management system (BRMS), and more particularly, to a method and system for realizing automatic adaptation of a data object model in the case that a data model has already been defined in an application system.

### BACKGROUND OF THE INVENTION

With the development of telecommunication industry, the implementation of enterprise market strategies is more and more dependent on information technology. Along with the implementation of information technology, the existing application systems, such as the systems of Business Operation Support System (BOSS), Billing, and Authentication & Authorization & Audit (AAA) become more and more complicated and enormous. Because of the development of complicated enterprise-level projects and the continuous change of business rules along with the exterior conditions, it is required to separate business rules from an application system and put these business rules in a central database or some other unified place to enable them to be managed and modified dynamically during operation. Thus, the flexibility and adaptability of the software system is improved. The BRMS is a solution to the above problem, which provides more flexibility for the implementation team of business application in technique, and allows professional developers to focus on the development of complicated tasks and business analyzers and strategy managers to take charge of simpler rule making and task revision, so that the business implementation team can deal with various changes related to enterprise business or technical environment more rapidly and effectively. In addition, the decision-making across IT and business departments will be expedited and the deployment time of new rules will be further shortened. A rule engine is the kernel of the BRMS, which accepts a rule triggering request and a data object model (DOM) of the application system. The rule engine loads a corresponding business rule, executes the business rule matching the DOM, and returns the execution result to the application system. However, because business rules are volatile, they will influence the stability and performance of the application system.

A technical solution in the prior art is as illustrated in FIG. 1: an application system directly invokes an external interface of a rule engine in a BRMS. The application system shall understand what rules the system needs, and design corresponding DOM objects according to the rules. The application system also needs to make corresponding changes when rules change. For example, there is a certain rule as following: if a customer is a VIP and female, the system will open a shopping-on-net service for her freely. The actual conditions for enforcing this rule are the customer's grade and gender. Therefore the DOM object, which the application system needs to provide to the rule engine, includes two data items of the customer's grade and gender. However, when the rule changes, for example, the rule is changed to be the following one: if a customer is a VIP and female with her age between 25 and 40, the system opens a shopping-on-net service for her freely. The rule has been added with a new condition of age. Although the application system has the age data, the DOM object provided to the rule engine does not change and does not have an attribute of age. Therefore, the application system must be modified to adapt to the new rule. Though the business rules have been separated to be processed from the application system, the application system can not automatically adapt to the change of the rules and needs to be modified with the specific change of the business rules.

### SUMMARY OF THE INVENTION

The present invention provides a method and system for realizing automatic adaptation of a data object model, which is used in an application system with a data model already defined therein, so that there is no need to modify the application system when rules change.

The technical solutions of the present invention are as follows:

A method for realizing automatic adaptation of a data object model includes the following processes: generating, by a business rule management system, a first data object model according to a second data object model, the first data object model being a data object model for use with a rule, the second data object model being a data object model provided by an application system, the first and second data object models being the same; analyzing, by the business rule management system, the first data object model, and generating an XML model according to a rule identifier provided by the application system and the first data object model, elements in the XML model being a subset of the first data object model; obtaining, by the application system, the XML model from the business rule management system, and updating a local XML model according to the obtained XML model, when determining that the rule of the business rule management system changes according to the rule identifier; generating, by the application system, an XML file complying with the rule by using the local XML model, and transferring the XML file and the rule identifier to the business rule management system; and generating, by the business rule management system, a data object model instance by using the XML file, and transferring the data object model instance to a rule engine to trigger the rule.

A system for realizing automatic adaptation of a data object model includes a business rule management subsystem and an application subsystem, the business rule management subsystem is further configured with a data object model module and an XML model module; the data object model module generates a first data object model according to a second data object model, the first data object model is a data object model for use with a rule, the second data object model is a data object model provided by the application subsystem; and the XML model module extracts a rule from a rule base according to a rule identifier provided by the application subsystem, and generates an XML model according to the rule and the first data object model.

The embodiments of the present invention provide a method and a system for realizing automatic adaptation of a data object model in an application system which has already defined a data model, which can adapt to dynamic change of a rule and also guarantee the stability of the application system.

### BRIEF DESCRIPTIONS OF THE DRAWINGS

FIG. 1 is a schematic diagram of invoking a BRMS by an application system in the prior art;

FIG. 2 is a flow chart of a method according to an embodiment of the present invention;

FIG. 3 is a schematic diagram illustrating the components according to an embodiment of the present invention;

FIG. 4 is a flow chart of generating an XML Schema by a BRMS according to an embodiment of the present invention;

FIG. 5 is a flow chart of generating a DOM instance by a BRMS according to an embodiment of the present invention; and

FIG. 6 is a general flow chart of triggering a rule by an application system according to an embodiment of the present invention.

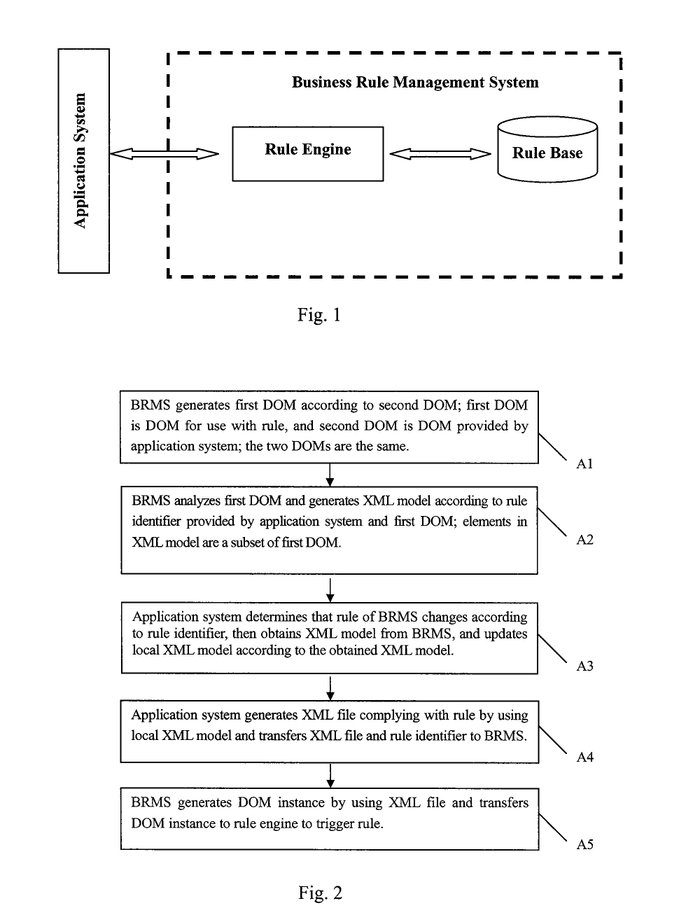

### DETAILED DESCRIPTIONS OF THE EMBODIMENTS

The method according to an embodiment of the present invention will be further described hereinafter with reference to the accompanying drawings.

According to some embodiments of the present invention, an application system has already defined a data model. When a rule in a BRMS changes, automatic adaptation of a DOM to the changed rule may be realized without modifying the application system as much as possible, via integrated application of DOM and Extensible Markup Language (XML) model.

Therefore, an embodiment of the present invention proposes a method for realizing automatic adaptation of a data object model as illustrated in FIG. 2, which particularly includes the following blocks:

Block A1: A business rule management system generates a first data object model according to a second data object model. The first data object model is a data object model for use with a rule, and the second data object model is a data object model provided by an application system. The first data object model and the second data object model are the same, which includes their element names, element numbers, and element types being the same. In other embodiment, there may be a process before block A1: the application system obtains a XML model from the business rule management system and stores the XML model.

Block A2: The business rule management system analyzes the first data object model, and generates an XML model according to a rule identifier provided by the application system and the first data object model. Elements in the XML model are a subset of the first data object model. A particular method of generating the XML model is as illustrated in FIG. 4 and will be described in detail later.

Block A3: The application system determines that a rule of the business rule management system changes according to the rule identifier, obtains the XML model from the business rule management system, and updates a local XML model according to the obtained XML model. Otherwise, the application system does not update the local XML model.

Block A4: The application system generates an XML file complying with the rule by using the local XML model, and transfers the XML file and the identifier of the rule to the business rule management system. A particular method of generating the XML file will be described in detail later.

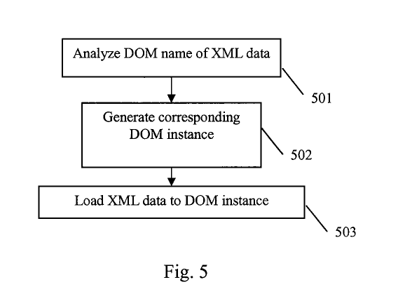

Block A5: The business rule management system generates a data object model instance by using the XML file, and transfers the data object model instance to the rule engine to trigger the rule. A particular method of generating a DOM instance is as shown in FIG. 5, and will be described in detail later.

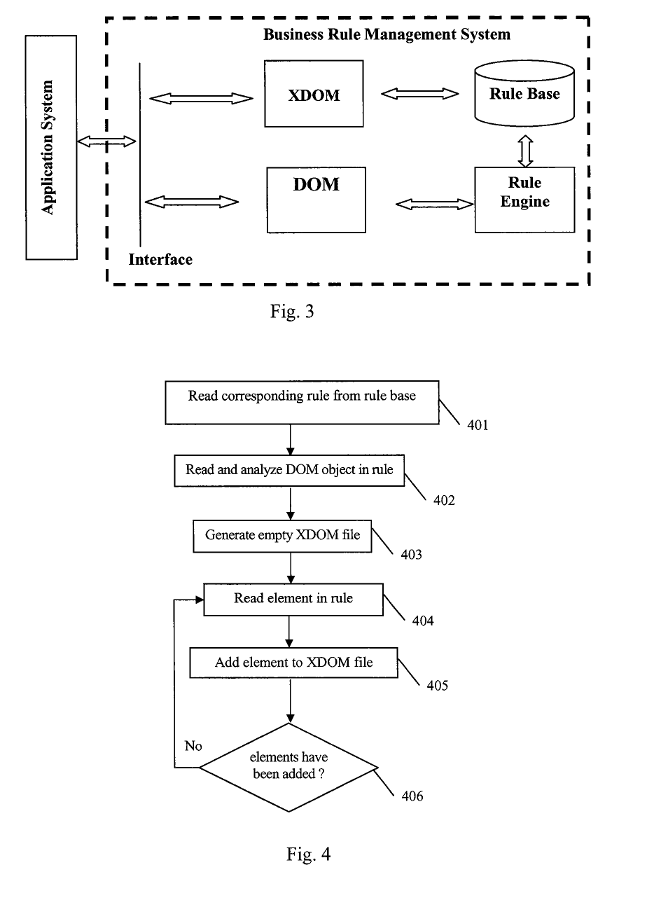

A schematic diagram of function modules according to an embodiment of the present invention is as shown in FIG. 3. An application system accesses a BRMS via a remote interface (an Enterprise JavaBean (EJB) interface, for example), and within the BRMS, a DOM, a rule engine, a XML model and a rule base are invoked by each other through internal API interfaces. The particular invoking method belongs to the prior art and will not be detailed here.

In the block A2, the process of generating the XML Schema (XML model, also called XDOM) by the BRMS includes the following blocks: The business rule management system obtains particular rule information from the rule base according to the rule identifier of the application system, and restores the rule information as an XML text; The business rule management system generates an empty XML model file according to data object model elements of the XML text; The business rule management system reads elements used by a condition of the XML text circularly and adds the elements to the XML model file, until all the elements of the XML text have been added. Of course, the business rule management system may also read the elements used by the condition of the XML file in a certain order, and there could be some other reading methods particularly as long as the adding of all the elements of the XML text can be completed. As shown in FIG. 4, a procedure of the process of generating the XML model is described in detail as follows:

Block 401: The BRMS obtains particular rule information from the rule base according to the rule identifier transferred by the application system, and restores the rule information as an XML text because the rules are stored in binary in the rule base;

Block 402: The XML text of the rule is analyzed and the name of an element DOM, e.g. Customer, is obtained;

Block 403: An empty XML file named after DOM, e.g. Customer.xsd, is generated;

Block 404: Elements used by the condition in the XML text of the rule, e.g. iGender, are read sequentially;

Block 405: The element iGender is added to the Customer.xsd; and

Block 406: The blocks 404 and 405 are repeated until all the elements used by the condition in the XML text of the rule are added to the Customer.xsd to generate a XDOM similar to the following one:

<xs:element name=“iGender”>
<xs:element name=“iAge”>.

FIG. 5 is a flow chart of generating the DOM instance by the BRMS, and the procedure is described in detail by the following blocks:

Block 501: The BRMS analyzes the XML data and obtains a DOM object used in the XML data; and the DOM object is a JavaBean object, e.g. Customer;

Block 502: A DOM instance is generated by using reflection mechanism of Java, e.g. new Customer( ); and

Block 503: A method of the Customer instance is invoked to load the XML data into the Customer instance, e.g., Customer.loadXML(Customer.xml). In the method .loadXML, the conversion from XML to DOM object instance is realized.

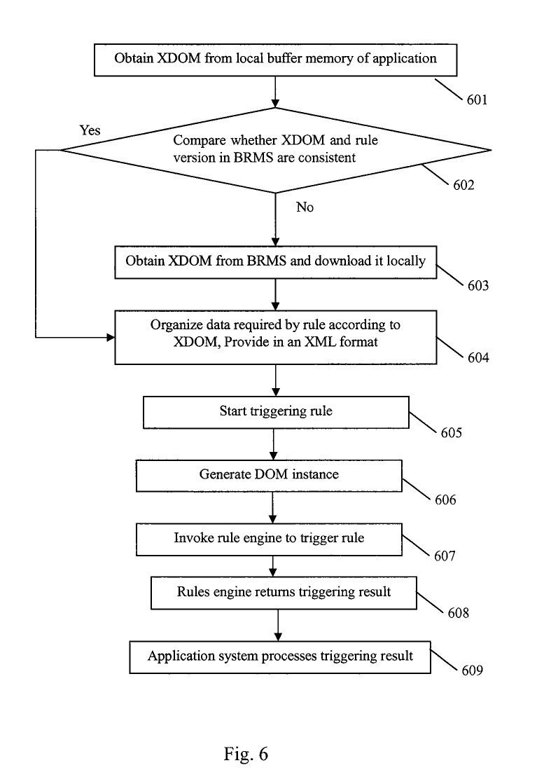

A general flow of triggering a rule by the application system is described in detail hereinafter, and it is particularly illustrated in FIG. 6.

With respect to the triggering procedure of a certain rule, the flow mainly includes the following blocks:

Block 601: The application system obtains a local XDOM;

Block 602: The application system compares the local XDOM and a corresponding rule version in the BRMS to determine whether they are consistent with each other, if not, the flow proceeds to the block 603. Otherwise, the flow jumps to block 604;

Block 603: The XDOM is downloaded locally from the BRMS by referring to the processing flow in FIG. 4;

Block 604: The XDOM obtained from the BRMS, e.g. Customer.xsd, is analyzed, and the values of the elements in the XDOM are obtained from the database. For example, age and gender of a certain customer are obtained from the database. A Customer.xml file is generated according to the XDOM to add the age and gender values of the customer to Customer.xml;

Block 605: The Customer.xml and a corresponding rule identifier are transferred to the BRMS;

Block 606: The DOM module analyzes the file Customer.xml (refer to FIG. 5) to generate a Customer object;

Block 607: The DOM instance Customer is transferred to the rule engine to trigger the rule;

Block 608: The rule engine feeds back the result of executing the rule to the application system; and

Block 609: The application system processes the triggering result.

In a practical application, for example, Partner in the database is defined as follows:

CREATE TABLE Partner(

partnerID VARCHAR(20) NOT NULL,
contractID VARCHAR(20) ,
partyID VARCHAR(20) NOT NULL,
partnerCode VARCHAR(20) ,
partnerType VARCHAR(20) NOT NULL,
partnerSubType VARCHAR(20) NOT NULL,
partnerGrade VARCHAR(20) ,
applyDate DATE ,
status VARCHAR(20) NOT NULL,
evaluateResult VARCHAR(20) ,
productInformation VARCHAR(20) ,
corperationplan VARCHAR(20) ,
addPerson VARCHAR(20) ,
addTime DATETIME year to second ,
lastUpdatePerson VARCHAR(20) ,
lastUpdateTime DATETIME year to second ,
settleMode VARCHAR(20) ,
creditGrade VARCHAR(20) ,
score INTEGER ,
belongToArea1 VARCHAR(20) ,
belongToArea2 VARCHAR(20) ,
belongToArea3 VARCHAR(20) ,
belongToDepartment VARCHAR(20) ,
creationChildEnanbled VARCHAR(20) ,
layer INTEGER ,
organizationID VARCHAR(20) ,
maxInventory VARCHAR(20) ,
maxAllChildNum VARCHAR(20) ,

PRIMARY KEY(partnerID));

According to an embodiment, the BRMS creates a rule according to the definition of the Partner. It is assumed that there is a rule: if the status of a Partner is active and his/her credit level is more than 100, then the grade of Partner is set as VIP. The application system analyzes an XDOM obtained from the BRMS, e.g. Partner.xsd, obtains the values of the elements in the XDOM from the database, for example, obtains the values of status and creditGrade from the database, generates a Partner.xml file according to the XDOM, adds the values of the status and creditGrade to the Partner.xml, and transfers the Partner.xml and a corresponding rule identifier to the BRMS. The DOM module analyzes the file Partner.xml (refer to FIG. 5) to generate a Partner object; the DOM instance Partner is then transferred to the rule engine to trigger the rule. The rule engine sets the result of executing the rule into partnerGrade in the Partner.xml to be fed back to the application system. The application system processes the triggering result and updates the value of partnerGrade to the database.

An embodiment of the present invention also provides a system for realizing automatic adaptation of a data object model, including a business rule management subsystem and an application subsystem. The business rule management subsystem being configured with a data object model module and an XML model module. The data object model module generates a first data object model according to a second data object model. The first data object model is a data object model for use with a rule, and the second data object model is a data object model provided by the application subsystem. The XML model module extracts a rule from a rule base according to a rule identifier provided by the application subsystem, and generates an XML model according to the rule and the first data object model. The data object model module is adapted for generating the first data object model, reading data of the second data object model, and writing the first data object model so that the second data object model and the first data object model are the same. The XML model module is adapted for obtaining particular rule information from the rule base and restoring the rule information into an XML text; generating an empty XML model file according to data object model elements of the XML text; and reading all the elements used by a condition of the XML text and adding the elements to the XML model file. The particular implementation method is as described above and as illustrated in FIG. 3. The application subsystem accesses the business rule management subsystem via a remote interface (an EJB interface), and within the business rule management subsystem, the DOM, the rule engine, the XML model and the rule base are invoked by each other through internal API interfaces.

It shall be understood that the above descriptions of the particular embodiments according to the present invention are relative specific and can not be construed as limiting the protection scope of the present invention, and the protection scope of the present invention shall be based on the appended claims.

What is claimed is:

1. A method for realizing automatic adaptation of a data object model, comprising:
generating, by a business rule management system, a first data object model according to a second data object model, the first data object model being a data object model for use with a rule, the second data object model being a data object model provided by an application system, the first and second data object models being the same;
analyzing, by the business rule management system, the first data object model, and generating an XML model according to a rule identifier provided by the application system and the first data object model, elements in the XML model being a subset of the first data object model;
obtaining, by the application system, the XML model from the business rule management system, and updating a local XML model according to the obtained XML model when determining that the rule of the business rule management system changes according to the rule identifier;
generating, by the application system, an XML file complying with the rule by using the local XML model and transferring the XML file and the rule identifier to the business rule management system; and
generating, by the business rule management system, a data object model instance by using the XML file, and transferring the data object model instance to a rule engine to trigger the rule.

2. The method according to claim 1, further comprising: obtaining, by the application system, the XML model from the business rule management system and storing the XML model before generating the first data object model.

3. The method according to claim 1, wherein the first and second data object models being the same comprises their element names, element numbers and element types being the same.

4. The method according to claim 1, wherein the analyzing the first data object model and generating an XML model further comprises:
obtaining, by the business rule management system, particular rule information from a rule base according to the rule identifier of the application system, and restoring the rule information as an XML text;
generating, by the business rule management system, an empty XML model file according to data object model elements of the XML text; and
reading, by the business rule management system, elements used by a condition of the XML text circularly, and adding the elements to the XML model file until all the elements of the XML text have been added.

5. The method according to claim 1, wherein the generating a data object model instance further comprises:
analyzing, by the business rule management system, the XML file, and obtaining an object of a data object model used in the XML data, the object of the data object model being a JavaBean object;
generating a data object model instance by using reflection mechanism of Java; and
loading data of the XML file to the data object model instance.

6. A system for realizing automatic adaptation of a data object model, comprising:
a business rule management subsystem and an application subsystem, wherein:
the business rule management subsystem is further configured with a data object model module and an XML model module;
the data object model module is adapted for generating a first data object model according to a second data object model, the first data object model being a data object model for use with a rule, the second data object model being a data object model provided by the application subsystem; and
the XML model module is adapted for extracting a rule from a rule base according to a rule identifier provided by the application subsystem, and generating an XML model according to the rule and the first data object model.

7. The system according to claim 6, wherein the data object model module is adapted for generating the first data object model, reading data of the second data object model, and writing the first data object model so that the second data object model and the first data object model are the same.

8. The system according to claim 6, wherein the XML model module is adapted for obtaining particular rule information from the rule base and restoring the rule information as an XML text; generating an empty XML model file according to data object model elements of the XML file; and reading all the elements used by a condition of the XML text and adding the elements to the XML model file.

9. A method for realizing automatic adaptation of a data object model, comprising:
generating a first data object model according to a second data object model, the first data object model being a data object model for use with a rule, the second data object model being a data object model provided by an application system, the first and second data object models being the same;
analyzing, the first data object model, and generating an XML model according to a rule identifier provided by the application system and the first data object model, elements in the XML model being a subset of the first data object model;
receiving an XML file and the rule identifier of the rule, the XML file being an XML file complying with the rule generated by the application system using a local XML model; and
generating a data object model instance by using the XML file, and transferring the data object model instance to a rule engine to trigger the rule.

10. The method according to claim 9, wherein the generating an XML model further comprises:
obtaining particular rule information from a rule base according to the rule identifier of the application system, and restoring the rule information as an XML text;
generating an empty XML model file according to data object model elements of the XML text; and
reading elements used by a condition of the XML text circularly, and adding the elements to the XML model file until all the elements of the XML text have been added.

11. The method according to claim 9, wherein the generating a data object model instance further comprises:
analyzing the XML file, and obtaining an object of a data object model used in the XML data, the object of the data object model being a JavaBean object;
generating a data object model instance by using reflection mechanism of Java; and
loading data of the XML file to the data object model instance.
